(19) United States
(12) Patent Application Publication
(10) Pub. No.: US 2025/0321391 A1
(43) Pub. Date: Oct. 16, 2025

(54) Signal Transmission Cable

(71) Applicant: Formerica OptoElectronics Inc., Hsinchu County (TW)

(72) Inventors: Peter Sin-Te Liu, Hsinchu County (TW); Joseph Chen-Kwo Liu, Hsinchu County (TW); Jack Hung-Fu Yeh, Hsinchu County (TW); Justin Chih-Chun Chiang, Hsinchu County (TW)

(21) Appl. No.: 19/176,590

(22) Filed: Apr. 11, 2025

Related U.S. Application Data
(60) Provisional application No. 63/633,122, filed on Apr. 12, 2024.

(30) Foreign Application Priority Data
Apr. 10, 2025 (TW) 114113498

(51) Int. Cl. G02B 6/42

(52) U.S. Cl. CPC G02B 6/4251; G02B 6/4246

(57) ABSTRACT

A signal transmission cable, comprising an optoelectronics transceiver and an extending optical cable, wherein the optoelectronics transceiver comprises an optoelectronics transceiver optical cable, wherein the optoelectronics transceiver optical cable is configured to transmit an optical signal, and the extending optical cable is configured to be joined with the optoelectronics transceiver optical cable so as to extend the transmission distance of the optical signal, such that the length of the optoelectronics transceiver optical cable does not need to be adjusted according to different usage scenarios or applications, thereby enabling mass production of the optoelectronics transceiver and reducing manufacturing costs.

### CROSS-REFERENCE TO RELATED APPLICATIONS

This application claims the priority of U.S. Patent Application No. 63/633,122 filed on Apr. 12, 2024 and the priority of Republic of China Patent Application No.114113498 filed on Apr. 10, 2025, in the State Intellectual Property Office of the R.O.C., the disclosure of which is incorporated herein by reference.

### BACKGROUND OF THE INVENTION

### Field of the Invention

The present application relates to an optical fiber communication technology, and more particularly, to a signal transmission cable that can be mass-produced to reduce manufacturing costs and prevent the infiltration of cooling liquid that may affect signal transmission.

### Descriptions of the Related Art

With the rapid development of network technology, optical fiber communication technology, due to its numerous advantages such as high transmission speed, long transmission distance, resistance to electromagnetic interference, and high security for data transmission, has gradually replaced conventional electrical communication technology used for signal transmission. As a result, optical fiber communication technology has now become a major communication technology in modern development, widely applied in information communication between various optical fiber network devices.

Optical fiber network devices in the optical fiber communication industry are often equipped with signal transmission cables. Generally, a signal transmission cable comprises an optoelectronics transceiver, which comprises an optoelectronics conversion module and an optoelectronics transceiver optical cable. The optoelectronics conversion module can convert an electrical signal into an optical signal or convert an optical signal into an electrical signal. The optoelectronics transceiver optical cable can connect the optoelectronics conversion module to the optical fiber network device, allowing optical signals to be transmitted between the optoelectronics conversion module and the optical fiber network device. However, the length of the optoelectronics transceiver optical cable is determined by the distance between the optoelectronics conversion module and the optical fiber network device, that is, the length of the optoelectronics transceiver optical cable depends on the transmission distance of the optical signal. The distance between the optoelectronics conversion module and the optical fiber network device may vary depending on the usage field or method, resulting in a need to customize the length of the optoelectronics transceiver optical cable, which hinders mass production of the optoelectronics transceiver and increases manufacturing costs.

Furthermore, since optical fiber network devices typically operate continuously for long periods, their operating temperature tends to rise, necessitating cooling. To cool optical fiber network devices, they are often immersed in high thermal conductivity cooling liquid, allowing the devices to operate in a liquid cooling environment. This helps dissipate the heat generated during the operation of optical fiber network devices quickly through the cooling liquid, thereby enhancing the performance and extending the service life of the devices.

However, if the optical fiber network devices are immersed in cooling liquid, the signal transmission cables connected to these devices must also be immersed. If the signal transmission cables do not possess good waterproof performance, cooling liquid may infiltrate the signal transmission cables, adversely affecting signal transmission.

In view of the above, it is a crucial challenge in the field to improve existing signal transmission cables to address the problem of customizing the extension length of optoelectronics transceiver optical cables, as well as enhancing the waterproof performance of signal transmission cables to prevent cooling liquid infiltration.

### SUMMARY OF THE INVENTION

In view of the various issues of the aforementioned prior art, the primary objective of the present application is to provide at least one type of signal transmission cable, allowing mass production to reduce manufacturing costs, while also preventing cooling liquid from infiltrating the signal transmission cable and affecting signal transmission.

To achieve the aforementioned objective and other purposes, the present application provides a signal transmission cable comprising: a major optoelectronics transceiver, the major optoelectronics transceiver comprising a major optoelectronics conversion module and a major optoelectronics transceiver optical cable, the major optoelectronics conversion module converting a major electrical signal into a major optical signal, or the major optoelectronics conversion module converting the major optical signal into the major electrical signal, the major optoelectronics transceiver optical cable providing transmission of the major optical signal, the major optoelectronics transceiver optical cable comprising a major optoelectronics transceiver optical cable joining end; an extending optical cable, one side of the extending optical cable comprising a major extending optical cable joining end; and a major optical cable connector, the major optical cable connector comprising a major optical cable connector carrier, a major optical cable connector cover, and a major optical cable connector adhesive, the major optical cable connector carrier comprising a major carrier joining space, wherein, the major extending optical cable joining end is joined with the major optoelectronics transceiver optical cable joining end within the major carrier joining space, such that the major optoelectronics transceiver optical cable transmits the major optical signal to the extending optical cable, and the extending optical cable extending to increase the transmission distance of the major optical signal; and the major optical cable connector adhesive bonding the major extending optical cable joining end and the major optoelectronics transceiver optical cable joining end within the major carrier joining space, thereby maintaining the joined state of the major extending optical cable joining end and the major optoelectronics transceiver optical cable joining end, and providing a sealed environment for the major extending optical cable joining end and the major optoelectronics transceiver optical cable joining end, with the major optical cable connector cover enclosing the major optical cable connector carrier to retain the major optical cable connector adhesive within the major carrier joining space.

Preferably, the signal transmission cable said above, wherein the major optoelectronics transceiver optical cable further comprises a major optoelectronics transceiver optical cable coupling component, and the extending optical cable further comprises a major extending optical cable coupling component; wherein the major optoelectronics transceiver optical cable coupling component and the major extending optical cable coupling component are provided to join and transmit the major optical signal, and the major optical cable connector adhesive comprises adhesive that bonds the major optoelectronics transceiver optical cable coupling component and the major extending optical cable coupling component, so as to maintain the joining relationship between the major optoelectronics transceiver optical cable coupling component and the major extending optical cable coupling component.

Preferably, the signal transmission cable said above, wherein the major optoelectronics transceiver optical cable further comprises a major optoelectronics transceiver optical cable fiber, and the extending optical cable further comprises an extending optical cable fiber, the major optoelectronics transceiver optical cable fiber and the extending optical cable fiber providing transmission of the major optical signal, and the major optical cable connector adhesive bonding the major optoelectronics transceiver optical cable fiber and the extending optical cable fiber to maintain the relative positional relationship of the major optoelectronics transceiver optical cable fiber and the extending optical cable fiber.

Preferably, the signal transmission cable said above, wherein the major optoelectronics transceiver optical cable further comprises a major optoelectronics transceiver optical cable cladding, and the extending optical cable further comprises an extending optical cable cladding, wherein the major optoelectronics transceiver optical cable cladding surrounds the major optoelectronics transceiver optical cable fiber, and the refractive index of the major optoelectronics transceiver optical cable cladding is lower than that of the major optoelectronics transceiver optical cable fiber, to provide total internal reflection ensuring the transmission of the major optical signal within the major optoelectronics transceiver extending optical cable fiber, and the refractive index of the extending optical cable cladding is lower than that of the extending optical cable fiber, to provide total internal reflection ensuring the transmission of the major optical signal within the extending optical cable fiber; a first major optoelectronics transceiver optical cable gap is formed between the major optoelectronics transceiver optical cable cladding and the major optoelectronics transceiver optical cable fiber; a first extending optical cable gap is formed between the extending optical cable cladding and the extending optical cable fiber; and the major optical cable connector adhesive comprises a first major optical cable connector sub-adhesive barrier layer, the first major optical cable connector sub-adhesive barrier layer is configured to respectively bond the major optoelectronics transceiver optical cable fiber, the major optoelectronics transceiver optical cable cladding, the extending optical cable fiber, and the extending optical cable cladding, so as to block continuity between the first major optoelectronics transceiver optical cable gap and the first extending optical cable gap.

Preferably, the signal transmission cable said above, wherein the major optoelectronics transceiver optical cable further comprises a major optoelectronics transceiver optical cable cushioning layer, and the extending optical cable further comprises an extending optical cable cushioning layer; the major optoelectronics transceiver optical cable cushioning layer is coated around the major optoelectronics transceiver optical cable cladding so as to protect the major optoelectronics transceiver optical cable fiber; the extending optical cable cushioning layer is coated around the extending optical cable cladding so as to protect the extending optical cable fiber; a second major optoelectronics transceiver optical cable gap is formed between the major optoelectronics transceiver optical cable cushioning layer and the major optoelectronics transceiver optical cable cladding, and a second extending optical cable gap is formed between the extending optical cable cushioning layer and the extending optical cable cladding; and the major optical cable connector adhesive comprises a second major optical cable connector sub-adhesive blocking layer, which is bonded respectively to the major optoelectronics transceiver optical cable cladding, the major optoelectronics transceiver optical cable cushioning layer, the extending optical cable cladding, and the extending optical cable cushioning layer, so as to block continuity between the second major optoelectronics transceiver optical cable gap and the second extending optical cable gap.

Preferably, the signal transmission cable said above, wherein the major optoelectronics transceiver optical cable further comprises a major optoelectronics transceiver optical cable reinforcement layer, and the extending optical cable further comprises an extending optical cable reinforcement layer, wherein the major optoelectronics transceiver optical cable reinforcement layer surrounds the major optoelectronics transceiver optoelectronics transceiver optical cable gap is formed between the major optoelectronics transceiver optical cable strengthening layer and the major optoelectronics transceiver optical cable cushioning layer, and a third extending optical cable gap is formed between the extending optical cable strengthening layer and the extending optical cable cushioning layer; and the major optical cable connector adhesive comprises a third major optical cable connector sub-adhesive blocking layer, which is bonded respectively to the major optoelectronics transceiver optical cable cushioning layer, the major optoelectronics transceiver optical cable strengthening layer, the extending optical cable cushioning layer, and the extending optical cable strengthening layer, so as to block continuity between the third major optoelectronics transceiver optical cable gap and the third extending optical cable gap.

Preferably, the signal transmission cable said above, wherein the major optoelectronics transceiver optical cable further comprises a major optoelectronics transceiver optical cable outer sheath layer, and the extending optical cable further comprises an extending optical cable outer sheath layer, wherein the major optoelectronics transceiver optical cable outer sheath layer surrounds the major optoelectronics transceiver optical cable reinforcement layer to provide outer protection; a fourth major optoelectronics transceiver optical cable gap is formed between the major optoelectronics transceiver optical cable outer sheath layer and the major optoelectronics transceiver optical cable strengthening layer, and a fourth extending optical cable gap is formed between the extending optical cable outer sheath layer and the extending optical cable strengthening layer; and the major optical cable connector adhesive comprises a fourth major optical cable connector sub-adhesive blocking layer, which is bonded respectively to the major optoelectronics transceiver optical cable strengthening layer, the major optoelectronics transceiver optical cable outer sheath layer, the extending optical cable strengthening layer, and the extending optical cable outer sheath layer, so as to block continuity between the fourth major optoelectronics transceiver optical cable gap and the fourth extending optical cable gap.

Preferably, the signal transmission cable said above, further comprising: a minor optoelectronics transceiver, the minor optoelectronics transceiver comprising a minor optoelectronics conversion module and a minor optoelectronics transceiver optical cable, the minor optoelectronics conversion module converting a minor electrical signal into a minor optical signal, or the minor optoelectronics conversion module converting the minor optical signal into the minor electrical signal, the minor optoelectronics transceiver optical cable providing transmission of the minor optical signal, the minor optoelectronics transceiver optical cable comprising a minor optoelectronics transceiver optical cable joining end; the other side of the extending optical cable comprising a minor extending optical cable joining end; and a minor optical cable connector, the minor optical cable connector comprising a minor optical cable connector carrier, a minor optical cable connector cover, and a minor optical cable connector adhesive, the minor optical cable connector carrier comprising a minor carrier joining space, wherein, the minor extending optical cable joining end is joined with the minor optoelectronics transceiver optical cable joining end within the minor carrier joining space, such that the minor optoelectronics transceiver optical cable transmits the minor optical signal to the extending optical cable, and the extending optical cable is capable of extending to increase the transmission distance of the minor optical signal; and the minor optical cable connector adhesive bonding the minor extending optical cable joining end and the minor optoelectronics transceiver optical cable joining end within the minor carrier joining space, thereby maintaining the joined state of the minor extending optical cable joining end and the minor optoelectronics transceiver optical cable joining end, and providing a sealed environment for the minor extending optical cable joining end and the minor optoelectronics transceiver optical cable joining end, with the minor optical cable connector cover enclosing the minor optical cable connector carrier to retain the minor optical cable connector adhesive within the minor carrier joining space.

Preferably, the signal transmission cable said above, wherein the minor optoelectronics transceiver optical cable further comprises a minor optoelectronics transceiver optical cable coupling component, and the extending optical cable further comprises a minor extending optical cable coupling component, the minor optoelectronics transceiver optical cable coupling component is joined with the minor extending optical cable coupling component to transmit the minor optical signal, and the minor optical cable connector adhesive is bonded to the minor optoelectronics transceiver optical cable coupling component and the minor extending optical cable coupling component so as to maintain the joining relationship between the minor optoelectronics transceiver optical cable coupling component and the minor extending optical cable coupling component.

Preferably, the signal transmission cable said above, wherein the minor optoelectronics transceiver optical cable further comprises a minor optoelectronics transceiver optical cable fiber, and the extending optical cable further comprises an extending optical cable fiber, the minor optoelectronics transceiver optical cable fiber and the extending optical cable fiber providing transmission of the minor optical signal, and the minor optical cable connector adhesive bonding the minor optoelectronics transceiver optical cable fiber and the extending optical cable fiber to maintain the relative positional relationship of the minor optoelectronics transceiver optical cable fiber and the extending optical cable fiber.

Preferably, the signal transmission cable said above, wherein the minor optoelectronics transceiver optical cable further comprises a minor optoelectronics transceiver optical cable cladding, and the extending optical cable further comprises an extending optical cable cladding, wherein the minor optoelectronics transceiver optical cable cladding surrounds the minor optoelectronics transceiver optical cable fiber, and the refractive index of the minor optoelectronics transceiver optical cable cladding is lower than that of the minor optoelectronics transceiver optical cable fiber, to provide total internal reflection ensuring the transmission of the minor optical signal within the minor optoelectronics transceiver optical cable fiber; the extending optical cable cladding surrounds the extending optical cable fiber, and the refractive index of the extending optical cable cladding is lower than that of the extending optical cable fiber, to provide total internal reflection ensuring the transmission of the minor optical signal within the extending optical cable fiber; and a first minor optoelectronics transceiver optical cable gap is formed between the minor optoelectronics transceiver optical cable cladding and the minor optoelectronics transceiver optical cable fiber; a first extending optical cable gap is formed between the extending optical cable cladding and the extending optical cable fiber; and the minor optical cable connector adhesive comprises a first minor optical cable connector sub-adhesive barrier layer, the first minor optical cable connector sub-adhesive barrier layer is configured to respectively bond the minor optoelectronics transceiver optical cable fiber, the minor optoelectronics transceiver optical cable cladding, the extending optical cable fiber, and the extending optical cable cladding, so as to block continuity between the first minor optoelectronics transceiver optical cable gap and the first extending optical cable gap.

Preferably, the signal transmission cable said above, wherein the minor optoelectronics transceiver optical cable further comprises a minor optoelectronics transceiver optical cable cushioning layer, and the extending optical cable further comprises an extending optical cable cushioning layer, wherein the minor optoelectronics transceiver optical cable cushioning layer surrounds the minor optoelectronics transceiver optical cable cladding to provide protection for the minor optoelectronics transceiver optical cable fiber; the extending optical cable cushioning layer surrounds the extending optical cable cladding to provide protection for the extending optical cable fiber; a second minor optoelectronics transceiver optical cable gap is formed between the minor optoelectronics transceiver optical cable cushioning layer and the minor optoelectronics transceiver optical cable cladding; a second extending optical cable gap is formed between the extending optical cable cushioning layer and the extending optical cable cladding; and the minor optical cable connector adhesive comprises a second minor optical cable connector sub-adhesive barrier layer, the second minor optical cable connector sub-adhesive barrier layer is configured to respectively bond the minor optoelectronics transceiver optical cable cladding, the minor optoelectronics transceiver optical cable cushioning layer, the extending optical cable cladding, and the extending optical cable cushioning layer, so as to block continuity between the second minor optoelectronics transceiver optical cable gap and the second extending optical cable gap.

Preferably, the signal transmission cable said above, wherein the minor optoelectronics transceiver optical cable further comprises a minor optoelectronics transceiver optical cable reinforcement layer, and the extending optical cable further comprises an extending optical cable reinforcement layer, wherein the minor optoelectronics transceiver optical cable reinforcement layer surrounds the minor optoelectronics transceiver optical cable cushioning layer to resist tensile force; the extending optical cable reinforcement layer surrounds the extending optical cable cushioning layer to resist tensile force; a third minor optoelectronics transceiver optical cable gap is formed between the minor optoelectronics transceiver optical cable reinforcement layer and the minor optoelectronics transceiver optical cable cushioning layer; a third extending optical cable gap is formed between the extending optical cable reinforcement layer and the extending optical cable cushioning layer; and the minor optical cable connector adhesive comprises a third minor optical cable connector sub-adhesive barrier layer, the third minor optical cable connector sub-adhesive barrier layer is configured to respectively bond the minor optoelectronics transceiver optical cable cushioning layer, the minor optoelectronics transceiver optical cable reinforcement layer, the extending optical cable cushioning layer, and the extending optical cable reinforcement layer, so as to block continuity between the third minor optoelectronics transceiver optical cable gap and the third extending optical cable gap.

Preferably, the signal transmission cable said above, wherein the minor optoelectronics transceiver optical cable further comprises a minor optoelectronics transceiver optical cable outer sheath layer, and the extending optical cable further comprises an extending optical cable outer sheath layer, wherein the minor optoelectronics transceiver optical cable outer sheath layer surrounds the minor optoelectronics transceiver optical cable reinforcement layer to provide outer protection; the extending optical cable outer sheath layer surrounds the extending optical cable reinforcement layer to provide outer protection; a fourth minor optoelectronics transceiver optical cable gap is formed between the minor optoelectronics transceiver optical cable outer sheath layer and the minor optoelectronics transceiver optical cable reinforcement layer; a fourth extending optical cable gap is formed between the extending optical cable outer sheath layer and the extending optical cable reinforcement layer; and the minor optical cable connector adhesive comprises a fourth minor optical cable connector sub-adhesive barrier layer, the fourth minor optical cable connector sub-adhesive barrier layer is configured to respectively bond the minor optoelectronics transceiver optical cable reinforcement layer, the minor optoelectronics transceiver optical cable outer sheath layer, the extending optical cable reinforcement layer, and the extending optical cable outer sheath layer, so as to block continuity between the fourth minor optoelectronics transceiver optical cable gap and the fourth extending

Compared with the prior art, the signal transmission cable of the present application comprises an optoelectronics transceiver, an extending optical cable, and an optical cable connector, wherein the optoelectronics transceiver comprises an optoelectronics transceiver optical cable, wherein the optoelectronics transceiver optical cable is configured to transmit an optical signal, and the extending optical cable is configured to be joined with the optoelectronics transceiver optical cable so as to extend the transmission distance of the optical signal, such that the length of the optoelectronics transceiver optical cable does not need to be changed according to different usage scenarios or application methods, thereby enabling mass production of the optoelectronics transceiver and reducing manufacturing costs.

Additionally, the optical cable connector comprises an optical cable connector adhesive, and the optical cable connector adhesive is configured to bond the joint between the extending optical cable and the optoelectronics transceiver optical cable; when the signal transmission cable is immersed in the cooling liquid, the optical cable connector adhesive is capable of preventing the cooling liquid from infiltrating the signal transmission cable through the joint between the extending optical cable and the optoelectronics transceiver optical cable, thereby significantly enhancing the waterproof performance of the signal transmission cable.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram showing a state in which the signal transmission cable of the present application is immersed in the cooling liquid.

FIG. 2 is a schematic diagram showing a state in which the signal transmission cable of the present application is immersed in the cooling liquid.

FIG. 3 is a schematic diagram showing a state in which the major optoelectronics transceiver optical cable and the extending optical cable fiber of the present application are joined.

FIG. 4 is a schematic diagram showing a state in which the minor optoelectronics transceiver optical cable and the extending optical cable fiber of the present application are joined.

FIG. 5 is a schematic diagram showing a state in which a portion of components of the major (or minor) optoelectronics transceiver optical cable and the extending optical cable fiber shown in FIG. 3 and FIG. 4 are joined.

FIG. 6 is a schematic diagram showing a state in which a portion of components of the major (or minor) optoelectronics transceiver optical cable and the extending optical cable fiber shown in FIG. 3 and FIG. 4 are joined.

FIG. 7 is a schematic diagram showing a state in which the major optoelectronics transceiver optical cable and the extending optical cable fiber of the present application are joined in the major optical cable connector.

FIG. 8 is a schematic diagram showing a state in which the minor optoelectronics transceiver optical cable and the extending optical cable fiber of the present application are joined in the minor optical cable connector.

FIG. 9 is a schematic diagram showing a state in which the major optoelectronics transceiver optical cable coupling component and the major extending optical cable coupling component of the present application are joined in the major optical cable connector.

FIG. 10 is a schematic diagram showing a state in which the minor optoelectronics transceiver optical cable coupling component and the minor extending optical cable coupling component of the present application are joined in the minor optical cable connector.

FIG. 11 is a schematic diagram showing a state in which a portion of components of the signal transmission cable of the present application is immersed in the cooling liquid.

FIG. 12 is a schematic diagram showing a state in which a portion of components of the signal transmission cable of the present application is immersed in the cooling liquid.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, it should be noted that for the sake of brevity and clarity, elements with the same or similar functions in the following embodiments will be denoted by the same symbols, and descriptions of identical or equivalent features will be omitted.

The present application provides a signal transmission cable, which comprises an optoelectronics transceiver and an extending optical cable. The optoelectronics transceiver comprises an optoelectronics transceiver optical cable, which can transmit an optical signal. The extending optical cable can join with the optoelectronics transceiver optical cable to extend the transmission distance of the optical signal. As a result, the length of the optoelectronics transceiver optical cable does not need to vary based on different usage fields or methods, thereby enabling mass production of the optoelectronics transceiver and reducing manufacturing costs.

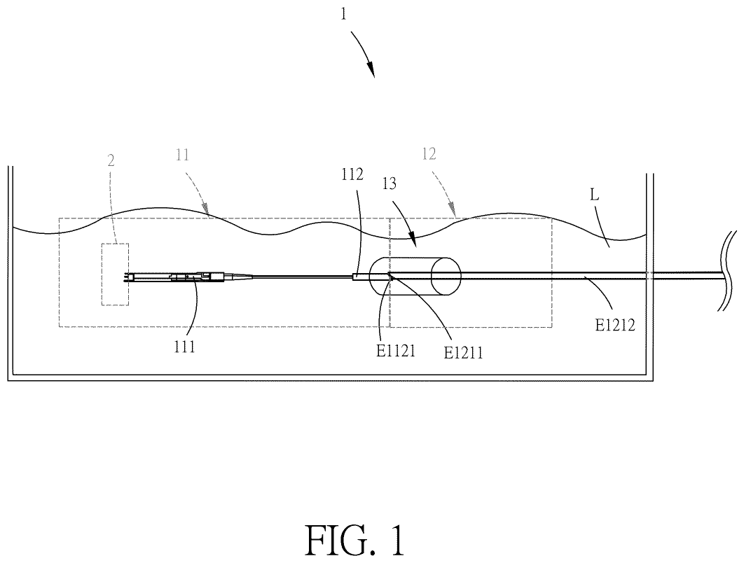

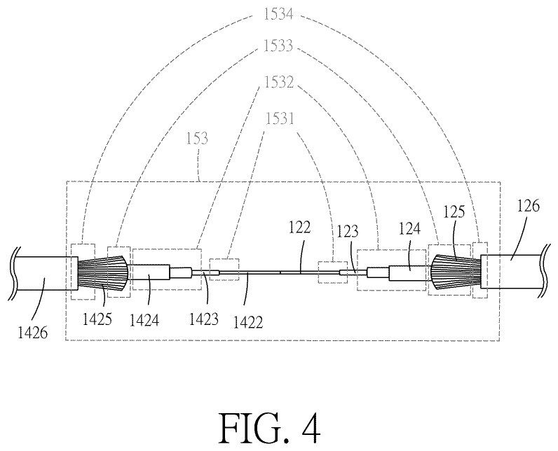

For a detailed description of the embodiments disclosed in the present application, please refer to FIGS. 1 to 12.

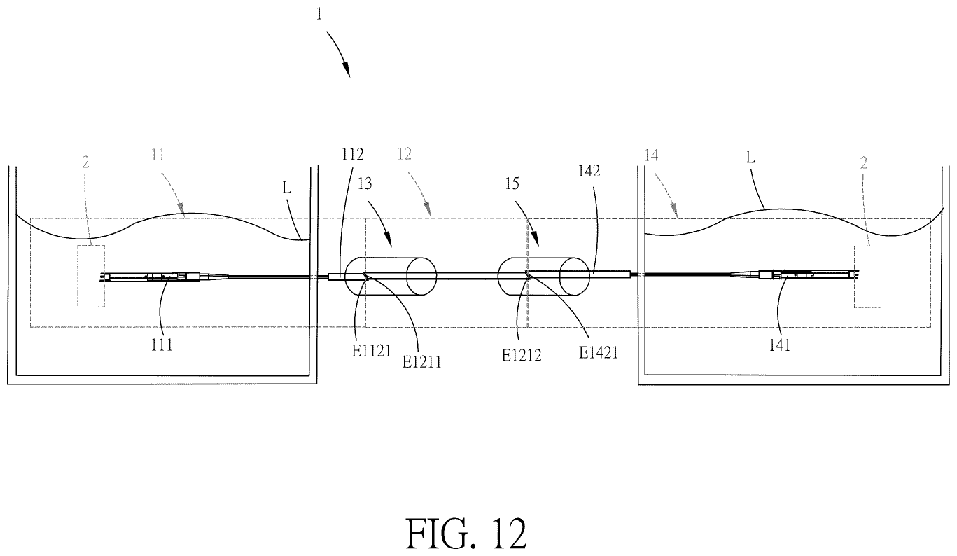

In the embodiments shown in FIGS. 1 and 12, at least one signal transmission cable 1 is provided. The signal transmission cable 1 can be inserted to an optical fiber network device 2 for signal transmission and comprises: a major optoelectronics transceiver 11, an extending optical cable 12, and a major optical cable connector 13.

It should be noted that, in the above embodiment, the optical fiber network device 2 can be immersed in a cooling liquid L with high thermal conductivity, allowing the optical fiber network device 2 to operate in a liquid cooling environment. This facilitates rapid dissipation of heat generated during the operation of the optical fiber network device 2 through the cooling liquid L, thereby enhancing the performance and lifespan of the optical fiber network device 2. Accordingly, the signal transmission cable 1 may be immersed in the cooling liquid L which has high thermal conductivity along with the optical fiber network device 2.

Regarding the major optoelectronics transceiver 11, and the major optoelectronics transceiver 11 comprises a major optoelectronics conversion module 111 and a major optoelectronics transceiver optical cable 112. The major optoelectronics conversion module 111 can convert a major electrical signal into a major optical signal, or convert the major optical signal into the major electrical signal. Additionally, the major optoelectronics transceiver optical cable 112 provides transmission of the major optical signal and comprises a major optoelectronics transceiver optical cable joining end E1121.

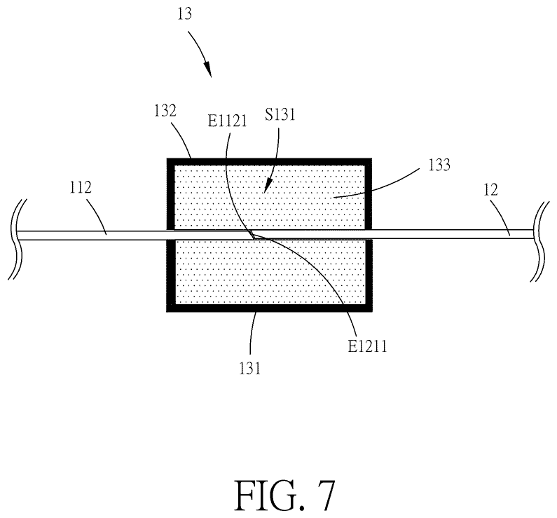

Regarding the extending optical cable 12, in the embodiment shown in FIG. 7, one side of the extending optical cable 12 comprises a major extending optical cable joining end E1211. In the above embodiment, the major extending optical cable joining end E1211 is structured to provide joining with other optical cables.

Regarding the major optical cable connector 13, in the embodiment shown in FIG. 7, and the major optical cable connector 13 comprises a major optical cable connector carrier 131, a major optical cable connector cover 132, and a major optical cable connector adhesive 133. The major optical cable connector carrier 131 comprises a major carrier joining space S131.

In the above embodiment, the major extending optical cable joining end E1211 can be join with the major optoelectronics transceiver optical cable joining end E1121 within the major carrier joining space S131, allowing the major optoelectronics transceiver optical cable 112 to transmit the major optical signal from the major extending optical cable joining end E1211 to the extending optical cable 12. The extending optical cable 12 can extend to increase the transmission distance of the major optical signal. It should be noted that the length of the extending optical cable 12 can be adjusted according to the distance between the major optoelectronics conversion module 111 and the optical fiber network device 2, thereby eliminating the need to change the length of the major optoelectronics transceiver optical cable 112 based on different usage fields or methods. Consequently, the major optoelectronics transceiver 11 can be mass-produced to reduce manufacturing costs.

Furthermore, the major optical cable connector adhesive 133 can bond the major extending optical cable joining end E1211 and the major optoelectronics transceiver optical cable joining end E1121 within the major carrier joining space S131, maintaining joining state of the major extending optical cable joining end E1211 and the major optoelectronics transceiver optical cable joining end E1121. The major optical cable connector adhesive 133 can provide a waterproof sealing environment that prevents the cooling liquid L from infiltrating for the major extending optical cable joining end E1211 and the major optoelectronics transceiver optical cable joining end E1121. Therefore, when the signal transmission cable 1 is immersed in the cooling liquid L along with the optical fiber network device 2, the major optical cable connector adhesive 133 can prevent the cooling liquid L from infiltrating the signal transmission cable 1 through the joining site between the major extending optical cable joining end E1211 and the major optoelectronics transceiver optical cable joining end E1121, thereby enhancing the waterproof performance of the signal transmission cable 1. The major optical cable connector cover 132 covers the major optical cable connector carrier 131 to constrain the flow range of the major optical cable connector adhesive 133, ensuring that the adhesive remains within the major carrier joining space S131 for aesthetic consistency.

It should be noted that, in the above embodiment, the major optical cable connector adhesive 133 may comprise, but is not limited to, epoxy resin (EPOXY) adhesive.

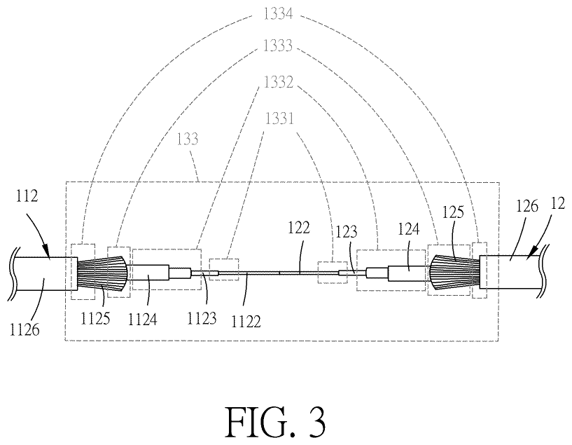

In the embodiments shown in FIGS. 3 to 6, the major optoelectronics transceiver optical cable 112 comprises a major optoelectronics transceiver optical cable fiber 1122. Correspondingly, the extending optical cable 12 comprises an extending optical cable fiber 122. The major optoelectronics transceiver optical cable fiber 1122 and the extending optical cable fiber 122 may be made of glass or plastic and are responsible for transmitting the major optical signal. The major optical cable connector adhesive 133 bonds the major optoelectronics transceiver optical cable fiber 1122 and the extending optical cable fiber 122 to maintain relative positional relationship of the major optoelectronics transceiver optical cable fiber 1122 and the extending optical cable fiber 122, thereby preventing separation and ensuring that the joining between the major extending optical cable joining end E1211 and the major optoelectronics transceiver optical cable joining end E1121 meets expectation.

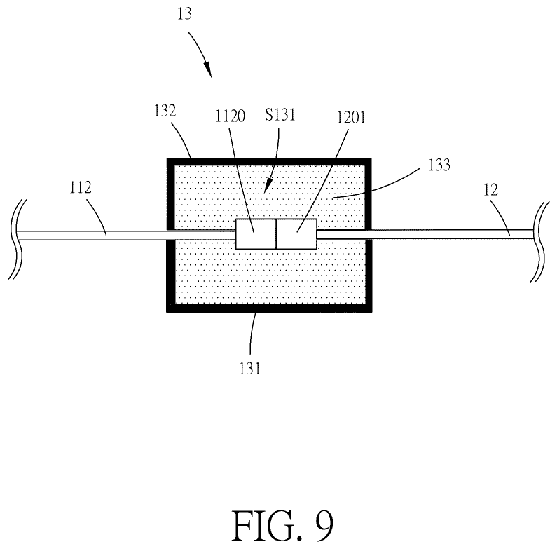

In the embodiment shown in FIG. 9, the major optoelectronics transceiver optical cable 112 comprises a major optoelectronics transceiver optical cable coupling component 1120. Correspondingly, the extending optical cable 12 comprises a major extending optical cable coupling component 1201. The major optoelectronics transceiver optical cable coupling component 1120 and the major extending optical cable coupling component 1201 are configured to join with each other to transmit the major optical signal. Correspondingly, the major optical cable connector adhesive 133 is bonded to the major optoelectronics transceiver optical cable coupling component 1120 and the major extending optical cable coupling component 1201 to maintain the mating relationship of the major optoelectronics transceiver optical cable coupling component 1120 and the major extending optical cable coupling component 1201.

Furthermore, the major optoelectronics transceiver optical cable 112 further comprises a major optoelectronics transceiver optical cable cladding 1123, which surrounds the major optoelectronics transceiver optical cable fiber 1122. The refractive index of the major optoelectronics transceiver optical cable cladding 1123 is lower than that of the major optoelectronics transceiver optical cable fiber 1122, providing total internal reflection to ensure the transmission of the major optical signal within the major optoelectronics transceiver optical cable fiber 1122. Correspondingly, the extending optical cable 12 comprises an extending optical cable cladding 123, which surrounds the extending optical cable fiber 122. The refractive index of the extending optical cable cladding 123 is lower than that of the extending optical cable fiber 122, providing total internal reflection to ensure the transmission of the major optical signal within the extending optical cable fiber 122.

It should be noted that, the major optical cable connector adhesive 133 bonds the major optoelectronics transceiver optical cable cladding 1123 and the extending optical cable cladding 123, maintaining relative positional relationship of the major optoelectronics transceiver optical cable cladding 1123 and the extending optical cable cladding 123 and preventing separation of the major optoelectronics transceiver optical cable cladding 1123 and the extending optical cable cladding 123, thereby ensuring the joining between the major extending optical cable joining end E1211 and the major optoelectronics transceiver optical cable joining end E1121 to meet the expectation.

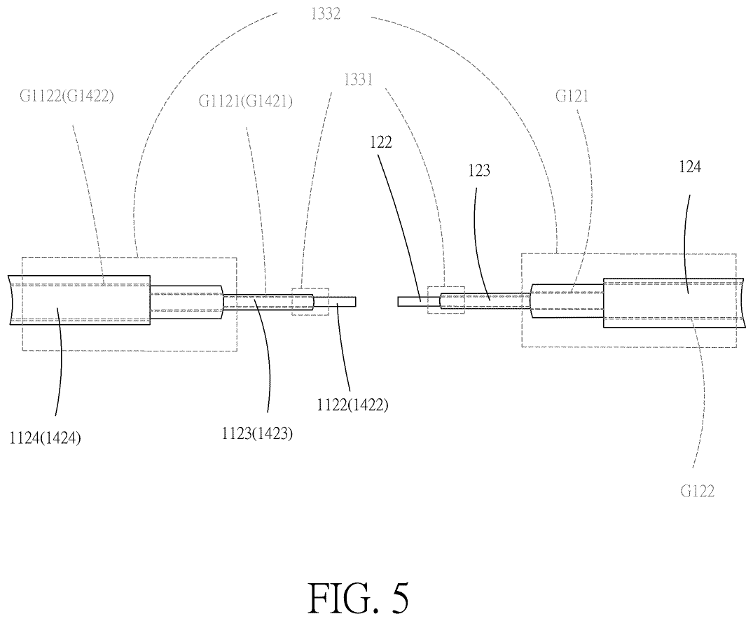

In the embodiment shown in FIG. 5, a first major optoelectronics transceiver optical cable gap G1121 is formed between the major optoelectronics transceiver optical cable cladding 1123 and the major optoelectronics transceiver optical cable fiber 1122, and a first extending optical cable gap G121 is formed between the extending optical cable cladding 123 and the extending optical cable fiber 122. Correspondingly, the major optical cable connector adhesive 133 comprises a first major optical cable connector sub-adhesive barrier layer 1331. The first major optical cable connector sub-adhesive barrier layer 1331 is bonded to the major optoelectronics transceiver optical cable fiber 1122, the major optoelectronics transceiver optical cable cladding 1123, the extending optical cable fiber 122, and the extending optical cable cladding 123, respectively, so as to block continuity between the first major optoelectronics transceiver optical cable gap G1121 and the first extending optical cable gap G121, thereby preventing the cooling liquid L from flowing between the first major optoelectronics transceiver optical cable gap G1121 and the first extending optical cable gap G121 via capillary action.

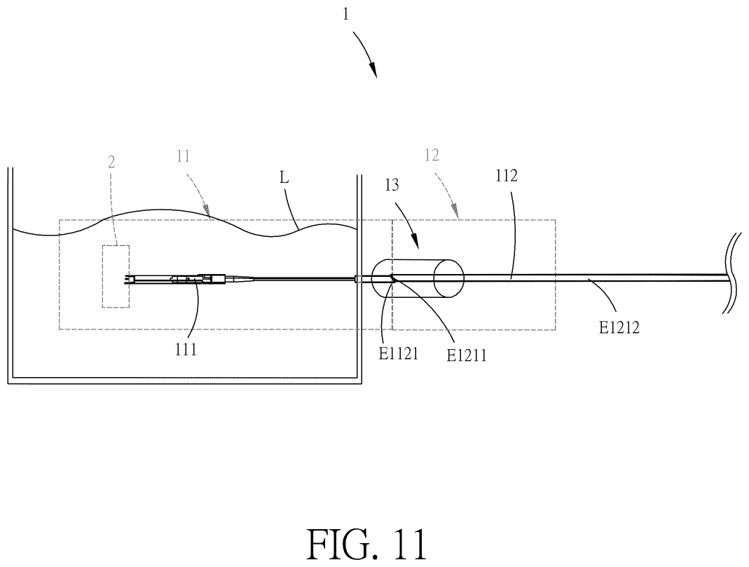

It should be noted that, in the embodiment shown in FIG. 11, when the major optical cable connector 13 is removed from the cooling liquid L, the first major optical cable connector sub-adhesive barrier layer 1331 is capable of preventing the cooling liquid L from flowing between the first major optoelectronics transceiver optical cable gap G1121 and the first extending optical cable gap G121 via capillary action, and subsequently seeping out through the major optical cable connector 13 to contaminate the environment.

Additionally, the major optoelectronics transceiver optical cable 112 further comprises a major optoelectronics transceiver optical cable cushioning layer 1124, which may be made of plastic materials such as acrylic or polymer. In the above embodiment, the major optoelectronics transceiver optical cable cushioning layer 1124 surrounds the major optoelectronics transceiver optical cable cladding 1123, providing protection to the major optoelectronics transceiver optical cable fiber 1122 against mechanical damage and environmental impact. Correspondingly, the extending optical cable 12 comprises an extending optical cable cushioning layer 124, which may be made of similar plastic materials. The extending optical cable cushioning layer 124 surrounds the extending optical cable cladding 123, providing protection to the extending optical cable fiber 122.

It should be noted that, the major optical cable connector adhesive 133 bonds the major optoelectronics transceiver optical cable cushioning layer 1124 and the extending optical cable cushioning layer 124, maintaining relative positional relationship of the major optoelectronics transceiver optical cable cushioning layer 1124 and the extending optical cable cushioning layer 124 and preventing separation of the major optoelectronics transceiver optical cable cushioning layer 1124 and the extending optical cable cushioning layer 124, thereby ensuring the joining between the major extending optical cable joining end E1211 and the major optoelectronics transceiver optical cable joining end E1121 to meet the expectation.

In the embodiment shown in FIG. 5, a second major optoelectronics transceiver optical cable gap G1122 is formed between the major optoelectronics transceiver optical cable cushioning layer 1124 and the major optoelectronics transceiver optical cable cladding 1123, and a second extending optical cable gap G122 is formed between the extending optical cable cushioning layer 124 and the extending optical cable cladding 123. Correspondingly, the major optical cable connector adhesive 133 comprises a second major optical cable connector sub-adhesive barrier layer 1332. The second major optical cable connector sub-adhesive barrier layer 1332 is bonded to the major optoelectronics transceiver optical cable cladding 1123, the major optoelectronics transceiver optical cable cushioning layer 1124, the extending optical cable cladding 123, and the extending optical cable cushioning layer 124, respectively, so as to block continuity between the second major optoelectronics transceiver optical cable gap G1122 and the second extending optical cable gap G122, thereby preventing the cooling liquid L from flowing between the second major optoelectronics transceiver optical cable gap G1122 and the second extending optical cable gap G122 via capillary action.

It should be noted that, in the embodiment shown in FIG. 11, when the major optical cable connector 13 is removed from the cooling liquid L, the second major optical cable connector sub-adhesive barrier layer 1332 is capable of preventing the cooling liquid L from flowing between the second major optoelectronics transceiver optical cable gap G1122 and the second extending optical cable gap G122 via capillary action, and subsequently seeping out through the major optical cable connector 13 to contaminate the environment.

Moreover, the major optoelectronics transceiver optical cable 112 further comprises a major optoelectronics transceiver optical cable reinforcement layer 1125, which may be made of reinforcement materials such as aramid (Kevlar), fiberglass, or steel wire. In the above embodiment, the major optoelectronics transceiver optical cable reinforcement layer 1125 surrounds the major optoelectronics transceiver optical cable cushioning layer 1124, providing additional mechanical strength to resist tensile forces and protect the major optoelectronics transceiver optical cable fiber 1122 from tensile damage. Correspondingly, the extending optical cable 12 comprises an extending optical cable reinforcement layer 125, which may also be made of reinforcement materials such as aramid, fiberglass, or steel wire. The extending optical cable reinforcement layer 125 surrounds the extending optical cable cushioning layer 124, providing additional mechanical strength to resist tensile forces and protect the extending optical cable fiber 122.

It should be noted that, the major optical cable connector adhesive 133 bonds the major optoelectronics transceiver optical cable reinforcement layer 1125 and the extending optical cable reinforcement layer 125 to maintain relative positional relationship of the major optoelectronics transceiver optical cable reinforcement layer 1125 and the extending optical cable reinforcement layer 125 and prevent separation of the major optoelectronics transceiver optical cable reinforcement layer 1125 and the extending optical cable reinforcement layer 125, thereby ensuring the joining relationship between the major extending optical cable joining end E1211 and the major optoelectronics transceiver optical cable joining end E1121 to meet the expectation.

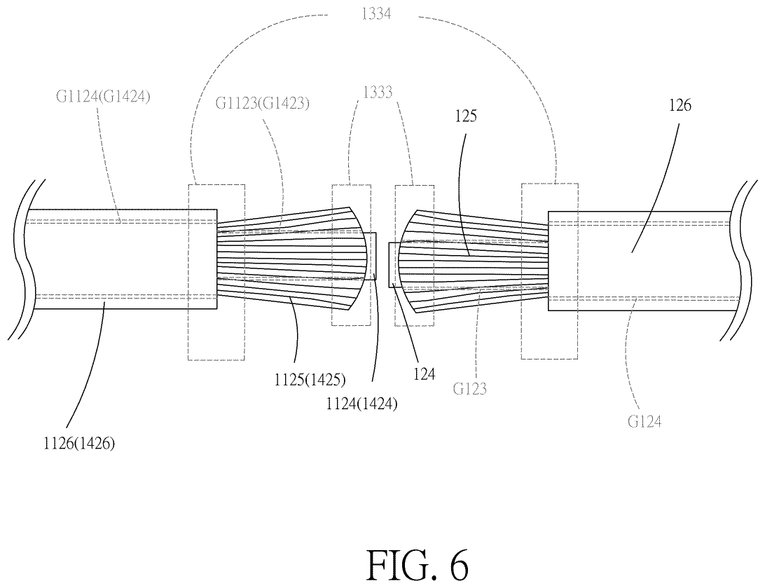

In the embodiment shown in FIG. 6, a third major optoelectronics transceiver optical cable gap G1123 is formed between the major optoelectronics transceiver optical cable reinforcement layer 1125 and the major optoelectronics transceiver optical cable cushioning layer 1124, and a third extending optical cable gap G123 is formed between the extending optical cable reinforcement layer 125 and the extending optical cable cushioning layer 124. Correspondingly, the major optical cable connector adhesive 133 comprises a third major optical cable connector sub-adhesive barrier layer 1333. The third major optical cable connector sub-adhesive barrier layer 1333 is bonded to the major optoelectronics transceiver optical cable cushioning layer 1124, the major optoelectronics transceiver optical cable reinforcement layer 1125, the extending optical cable cushioning layer 124, and the extending optical cable reinforcement layer 125, respectively, so as to block continuity between the third major optoelectronics transceiver optical cable gap G1123 and the third extending optical cable gap G123, thereby preventing the cooling liquid L from flowing between the third major optoelectronics transceiver optical cable gap G1123 and the third extending optical cable gap G123 via capillary action.

It should be noted that, in the embodiment shown in FIG. 11, when the major optical cable connector 13 is removed from the cooling liquid L, the third major optical cable connector sub-adhesive barrier layer 1333 is capable of preventing the cooling liquid L from flowing between the third major optoelectronics transceiver optical cable gap G1123 and the third extending optical cable gap G123 via capillary action, and subsequently seeping out through the major optical cable connector 13 to contaminate the environment.

Furthermore, the major optoelectronics transceiver optical cable 112 further comprises a major optoelectronics transceiver optical cable outer sheath layer 1126, which may be made of materials such as polyethylene (PE), polyvinyl chloride (PVC), or polyurethane (PU). In the above embodiment, the major optoelectronics transceiver optical cable outer sheath layer 1126 surrounds the major optoelectronics transceiver optical cable reinforcement layer 1125, providing outer protection against water, UV radiation, and chemical corrosion. Correspondingly, the extending optical cable 12 comprises an extending optical cable outer sheath layer 126, which may also be made of similar materials. The extending optical cable outer sheath layer 126 surrounds the extending optical cable reinforcement layer 125, providing outer protection.

It should be noted that, the major optical cable connector adhesive 133 bonds the major optoelectronics transceiver optical cable outer sheath layer 1126 and the extending optical cable outer sheath layer 126, maintaining relative positional relationship of the major optoelectronics transceiver optical cable outer sheath layer 1126 and the extending optical cable outer sheath layer 126, and preventing separation of the major optoelectronics transceiver optical cable outer sheath layer 1126 and the extending optical cable outer sheath layer 126, thereby ensuring the joining relationship between the major extending optical cable joining end E1211 and the major optoelectronics transceiver optical cable joining end E1121 to meet the expectation.

In the embodiment shown in FIG. 6, a fourth major optoelectronics transceiver optical cable gap G1124 is formed between the major optoelectronics transceiver optical cable outer sheath layer 1126 and the major optoelectronics transceiver optical cable reinforcement layer 1125, and a fourth extending optical cable gap G124 is formed between the extending optical cable outer sheath layer 126 and the extending optical cable reinforcement layer 125. Correspondingly, the major optical cable connector adhesive 133 comprises a fourth major optical cable connector sub-adhesive barrier layer 1334. The fourth major optical cable connector sub-adhesive barrier layer 1334 is bonded to the major optoelectronics transceiver optical cable reinforcement layer 1125, the major optoelectronics transceiver optical cable outer sheath layer 1126, the extending optical cable reinforcement layer 125, and the extending optical cable outer sheath layer 126, respectively, so as to block continuity between the fourth major optoelectronics transceiver optical cable gap G1124 and the fourth extending optical cable gap G124, thereby preventing the cooling liquid L from flowing between the fourth major optoelectronics transceiver optical cable gap G1124 and the fourth extending optical cable gap G124 via capillary action.

It should be noted that, in the embodiment shown in FIG. 11, when the major optical cable connector 13 is removed from the cooling liquid L, the fourth major optical cable connector sub-adhesive barrier layer 1334 is capable of preventing the cooling liquid L from flowing between the fourth major optoelectronics transceiver optical cable gap G1124 and the fourth extending optical cable gap G124 via capillary action, and subsequently seeping out through the major optical cable connector 13 to contaminate the environment.

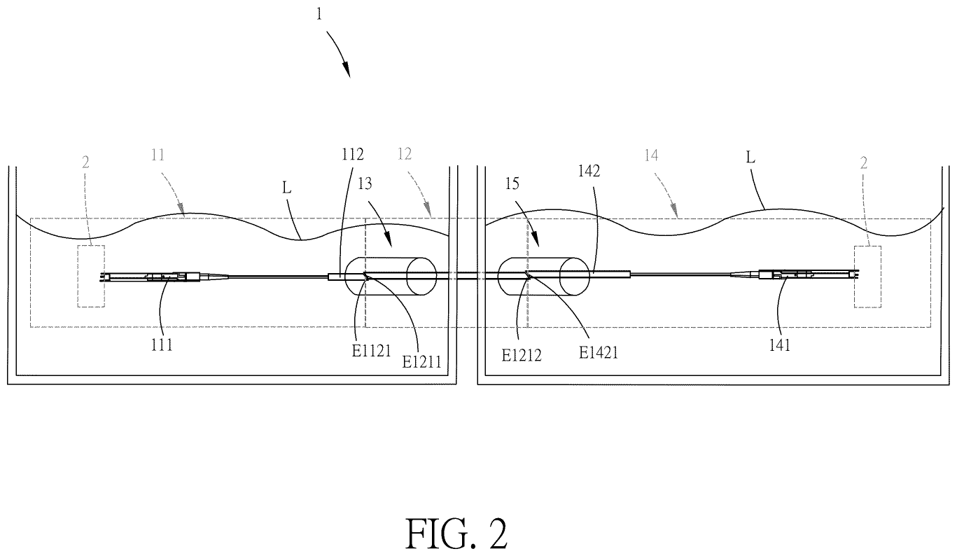

In the embodiments shown in FIG. 2, the signal transmission cable 1 further comprises: a minor optoelectronics transceiver 14.

Regarding the minor optoelectronics transceiver 14, it comprises a minor optoelectronics conversion module 141 and a minor optoelectronics transceiver optical cable 142. The minor optoelectronics conversion module 141 can convert a minor electrical signal into a minor optical signal or convert the minor optical signal into the minor electrical signal. Additionally, the minor optoelectronics transceiver optical cable 142 provides transmission of the minor optical signal and comprises a minor optoelectronics transceiver optical cable joining end E1421.

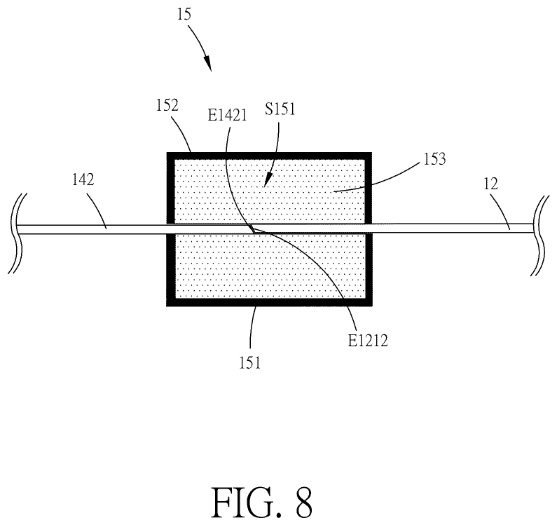

Regarding the extending optical cable 12, in the embodiment shown in FIG. 8, the other side of the extending optical cable 12 comprises a minor extending optical cable joining end E1212. In the above embodiment, the minor extending optical cable joining end E1212 is structured to join with other optical cables.

Regarding the minor optical cable connector 15, in the embodiment shown in FIG. 8, the minor optical cable connector 15 comprises a minor optical cable connector carrier 151, a minor optical cable connector cover 152, and a minor optical cable connector adhesive 153. The minor optical cable connector carrier 151 comprises a minor carrier joining space S151.

In the above embodiment, the minor extending optical cable joining end E1212 can be joined with the minor optoelectronics transceiver optical cable joining end E1421 within the minor carrier joining space S151. This configuration allows the minor optoelectronics transceiver optical cable 142 to transmit the minor optical signal from the minor extending optical cable joining end E1212 to the extending optical cable 12, thereby extending the transmission distance of the minor optical signal. It should be noted that the length of the extending optical cable 12 can be adjusted according to the distance between the minor optoelectronics conversion module 141 and the optical fiber network device 2, thereby eliminating the need to change the length of the minor optoelectronics transceiver optical cable 142 according to different usage fields or methods, enabling mass production of the minor optoelectronics transceiver 14 and reducing manufacturing costs.

Additionally, the minor optical cable connector adhesive 153 can bond the minor extending optical cable joining end E1212 and the minor optoelectronics transceiver optical cable joining end E1421 within the minor carrier joining space S151, thereby maintaining joining state of the minor extending optical cable joining end E1212 and the minor optoelectronics transceiver optical cable joining end E1421. The minor optical cable connector adhesive 153 also provides a waterproof sealing environment that prevents the cooling liquid L from penetrating the joint between the minor extending optical cable joining end E1212 and the minor optoelectronics transceiver optical cable joining end E1421. Therefore, when the signal transmission cable 1 is immersed in the cooling liquid L along with the optical fiber network device 2, the minor optical cable connector adhesive 153 effectively prevents the cooling liquid L infiltration at the joining site, thereby enhancing the waterproof performance of the signal transmission cable 1. The minor optical cable connector cover 152 covers the minor optical cable connector carrier 151 to constrain the flow range of the minor optical cable connector adhesive 153, ensuring that the adhesive remains within the minor carrier joining space S151 for aesthetic consistency.

It should be noted that, in the above embodiment, the minor optical cable connector adhesive 153 may comprise, but is not limited to, epoxy (EPOXY) adhesive.

In the embodiments shown in FIGS. 3 to 6, the minor optoelectronics transceiver optical cable 142 comprises a minor optoelectronics transceiver optical cable fiber 1422. Correspondingly, the extending optical cable 12 comprises an extending optical cable fiber 122. The minor optoelectronics transceiver optical cable fiber 1422 and the extending optical cable fiber 122 may be made of glass or plastic and are responsible for transmitting the minor optical signal. The minor optical cable connector adhesive 153 bonds the minor optoelectronics transceiver optical cable fiber 1422 and the extending optical cable fiber 122 to maintain relative positional relationship of the minor optoelectronics transceiver optical cable fiber 1422 and the extending optical cable fiber 122, thereby preventing separation of the minor optoelectronics transceiver optical cable fiber 1422 and the extending optical cable fiber 122 and ensuring that the joining between the minor extending optical cable joining end E1212 and the minor optoelectronics transceiver optical cable joining end E1421 meets expectation.

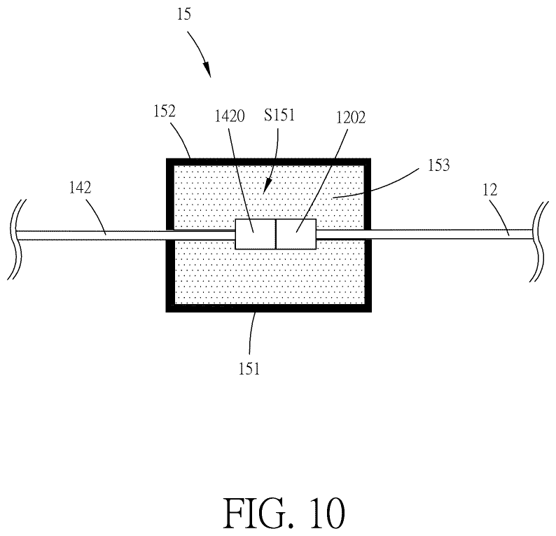

In the embodiment shown in FIG. 10, the minor optoelectronics transceiver optical cable 142 further comprises a minor optoelectronics transceiver optical cable coupling component 1420. Correspondingly, the extending optical cable 12 further comprises a minor extending optical cable coupling component 1202. The minor optoelectronics transceiver optical cable coupling component 1420 and the minor extending optical cable coupling component 1202 are joined with each other to transmit the minor optical signal, and the minor optical cable connector adhesive is bonded to the minor optoelectronics transceiver optical cable coupling component 1420 and the minor extending optical cable coupling component 1202 so as to maintain the joined relationship between the minor optoelectronics transceiver optical cable coupling component 1420 and the minor extending optical cable coupling component 1202.

Furthermore, the minor optoelectronics transceiver optical cable 142 further comprises a minor optoelectronics transceiver optical cable cladding 1423, which surrounds the minor optoelectronics transceiver optical cable fiber 1422. The refractive index of the minor optoelectronics transceiver optical cable cladding 1423 is lower than that of the minor optoelectronics transceiver optical cable fiber 1422, providing total internal reflection to ensure the transmission of the minor optical signal within the minor optoelectronics transceiver optical cable fiber 1422. Correspondingly, the extending optical cable 12 comprises an extending optical cable cladding 123, which surrounds the extending optical cable fiber 122. The refractive index of the extending optical cable cladding 123 is lower than that of the extending optical cable fiber 122, providing total internal reflection to ensure the transmission of the minor optical signal within the extending optical cable fiber 122. The minor optical cable connector adhesive 153 bonds the minor optoelectronics transceiver optical cable cladding 1423 and the extending optical cable cladding 123 to maintain relative positional relationship of the minor optoelectronics transceiver optical cable cladding 1423 and the extending optical cable cladding 123, thereby preventing separation of the minor optoelectronics transceiver optical cable cladding 1423 and the extending optical cable cladding 123 and ensuring that the joining between the minor extending optical cable joining end E1212 and the minor optoelectronics transceiver optical cable joining end E1421 meets expectation.

In the embodiment shown in FIG. 5, a first minor optoelectronics transceiver optical cable gap G1421 is formed between the minor optoelectronics transceiver optical cable cladding 1423 and the minor optoelectronics transceiver optical cable fiber 1422, and a first extending optical cable gap G121 is formed between the extending optical cable cladding 123 and the extending optical cable fiber 122. Correspondingly, the minor optical cable connector adhesive 153 comprises a first minor optical cable connector sub-adhesive barrier layer 1531. The first minor optical cable connector sub-adhesive barrier layer 1531 is bonded to the minor optoelectronics transceiver optical cable fiber 1422, the minor optoelectronics transceiver optical cable cladding 1423, the extending optical cable fiber 122, and the extending optical cable cladding 123, respectively, so as to block continuity between the first minor optoelectronics transceiver optical cable gap G1421 and the first extending optical cable gap G121, thereby preventing the cooling liquid L from flowing between the first minor optoelectronics transceiver optical cable gap G1421 and the first extending optical cable gap G121 via capillary action.

It should be noted that, in the embodiment shown in FIG. 12, when the minor optical cable connector 15 is removed from the cooling liquid L, the first minor optical cable connector sub-adhesive barrier layer 1531 is capable of preventing the cooling liquid L from flowing between the first minor optoelectronics transceiver optical cable gap G1421 and the first extending optical cable gap G121 via capillary action, and subsequently seeping out through the minor optical cable connector 15 to contaminate the environment.

Moreover, the minor optoelectronics transceiver optical cable 142 further comprises a minor optoelectronics transceiver optical cable cushioning layer 1424, which may be made of plastic materials such as acrylic or polymer. In the above embodiment, the minor optoelectronics transceiver optical cable cushioning layer 1424 surrounds the minor optoelectronics transceiver optical cable cladding 1423, providing protection against mechanical damage and environmental impact. Correspondingly, the extending optical cable 12 comprises an extending optical cable cushioning layer 124 made of similar materials, surrounding the extending optical cable cladding 123 to provide similar protection.

It should be noted that, the minor optical cable connector adhesive 153 bonds the minor optoelectronics transceiver optical cable cushioning layer 1424 and the extending optical cable cushioning layer 124 to maintain relative positional relationship of the minor optoelectronics transceiver optical cable cushioning layer 1424 and the extending optical cable cushioning layer 124 and prevent separation of the minor optoelectronics transceiver optical cable cushioning layer 1424 and the extending optical cable cushioning layer 124, ensuring that the joining relationship between the minor extending optical cable joining end E1212 and the minor optoelectronics transceiver optical cable joining end E1421 meets expectation.

In the embodiment shown in FIG. 5, a second minor optoelectronics transceiver optical cable gap G1422 is formed between the minor optoelectronics transceiver optical cable cushioning layer 1424 and the minor optoelectronics transceiver optical cable cladding 1123, and a second extending optical cable gap G122 is formed between the extending optical cable cushioning layer 124 and the extending optical cable cladding 123. Correspondingly, the minor optical cable connector adhesive 153 comprises a second minor optical cable connector sub-adhesive barrier layer 1532. The second minor optical cable connector sub-adhesive barrier layer 1532 is bonded to the minor optoelectronics transceiver optical cable cladding 1123, the minor optoelectronics transceiver optical cable cushioning layer 124, the extending optical cable cladding 123, and the extending optical cable cushioning layer 124, respectively, so as to block continuity between the second minor optoelectronics transceiver optical cable gap G1422 and the second extending optical cable gap G122, thereby preventing the cooling liquid L from flowing between the second minor optoelectronics transceiver optical cable gap G1422 and the second extending optical cable gap G122 via capillary action.

It should be noted that, in the embodiment shown in FIG. 12, when the minor optical cable connector 15 is removed from the cooling liquid L, the second minor optical cable connector sub-adhesive barrier layer 1532 is capable of preventing the cooling liquid L from flowing between the second minor optoelectronics transceiver optical cable gap G1422 and the second extending optical cable gap G122 via capillary action, and subsequently seeping out through the minor optical cable connector 15 to contaminate the environment.

Furthermore, the minor optoelectronics transceiver optical cable 142 comprises a minor optoelectronics transceiver optical cable reinforcement layer 1425, made of materials such as aramid (Kevlar), fiberglass, or steel wire, surrounding the minor optoelectronics transceiver optical cable cushioning layer 1424 to provide mechanical strength against tensile forces. Correspondingly, the extending optical cable 12 comprises an extending optical cable reinforcement layer 125, made of similar materials, surrounding the extending optical cable cushioning layer 124 to resist tensile forces.

It should be noted that, the minor optical cable connector adhesive 153 bonds the minor optoelectronics transceiver optical cable reinforcement layer 1425 and the extending optical cable reinforcement layer 125, maintaining relative positional relationship of the minor optoelectronics transceiver optical cable reinforcement layer 1425 and the extending optical cable reinforcement layer 125 and preventing separation of the minor optoelectronics transceiver optical cable reinforcement layer 1425 and the extending optical cable reinforcement layer 125, ensuring that the joining relationship between the minor extending optical cable joining end E1212 and the minor optoelectronics transceiver optical cable joining end E1421 conforms to expectation.

In the embodiment shown in FIG. 6, a third minor optoelectronics transceiver optical cable gap G1423 is formed between the minor optoelectronics transceiver optical cable reinforcement layer 1425 and the minor optoelectronics transceiver optical cable cushioning layer 1424, and a third extending optical cable gap G123 is formed between the extending optical cable reinforcement layer 125 and the extending optical cable cushioning layer 124. Correspondingly, the minor optical cable connector adhesive 153 comprises a third minor optical cable connector sub-adhesive barrier layer 1533. The third minor optical cable connector sub-adhesive barrier layer 1533 is bonded to the minor optoelectronics transceiver optical cable cushioning layer 1424, the minor optoelectronics transceiver optical cable reinforcement layer 1425, the extending optical cable cushioning layer 124, and the extending optical cable reinforcement layer 125, respectively, so as to block continuity between the third minor optoelectronics transceiver optical cable gap G1423 and the third extending optical cable gap G123, thereby preventing the cooling liquid L from flowing between the third minor optoelectronics transceiver optical cable gap G1423 and the third extending optical cable gap G123 via capillary action.

It should be noted that, in the embodiment shown in FIG. 12, when the minor optical cable connector 15 is removed from the cooling liquid L, the third minor optical cable connector sub-adhesive barrier layer 1533 is capable of preventing the cooling liquid L from flowing between the third minor optoelectronics transceiver optical cable gap G1423 and the third extending optical cable gap G123 via capillary action, and subsequently seeping out through the minor optical cable connector 15 to contaminate the environment.

Additionally, the minor optoelectronics transceiver optical cable 142 further comprises a minor optoelectronics transceiver optical cable outer sheath layer 1426, which may be made of materials such as polyethylene (PE), polyvinyl chloride (PVC), or polyurethane (PU). In the above embodiment, the minor optoelectronics transceiver optical cable outer sheath layer 1426 surrounds the minor optoelectronics transceiver optical cable reinforcement layer 1425 to provide outer protection, comprising waterproofing, UV resistance, and chemical corrosion resistance. Correspondingly, the extending optical cable 12 comprises an extending optical cable outer sheath layer 126, which may also be made of materials such as polyethylene (PE), polyvinyl chloride (PVC), or polyurethane (PU). In the above embodiment, the extending optical cable outer sheath layer 126 surrounds the extending optical cable reinforcement layer 125 to provide outer protection, comprising waterproofing, UV resistance, and chemical corrosion resistance.

It should be noted that, the minor optical cable connector adhesive 153 bonds the minor optoelectronics transceiver optical cable outer sheath layer 1426 and the extending optical cable outer sheath layer 126, maintaining relative positional relationship of the minor optoelectronics transceiver optical cable outer sheath layer 1426 and the extending optical cable outer sheath layer 126 and preventing separation of the minor optoelectronics transceiver optical cable outer sheath layer 1426 and the extending optical cable outer sheath layer 126 ensuring that the joining relationship between the minor extending optical cable joining end E1212 and the minor optoelectronics transceiver optical cable joining end E1421 meets expectation.

In the embodiment shown in FIG. 6, a fourth minor optoelectronics transceiver optical cable gap G1424 is formed between the minor optoelectronics transceiver optical cable outer sheath layer 1426 and the minor optoelectronics transceiver optical cable reinforcement layer 1425, and a fourth extending optical cable gap G124 is formed between the extending optical cable outer sheath layer 126 and the extending optical cable reinforcement layer 125. Correspondingly, the minor optical cable connector adhesive 153 comprises a fourth minor optical cable connector sub-adhesive barrier layer 1534. The fourth minor optical cable connector sub-adhesive barrier layer 1534 is bonded respectively to the minor optoelectronics transceiver optical cable reinforcement layer 1425, the minor optoelectronics transceiver optical cable outer sheath layer 1426, the extending optical cable reinforcement layer 125, and the extending optical cable outer sheath layer 126, so as to block continuity between the fourth minor optoelectronics transceiver optical cable gap G1424 and the fourth extending optical cable gap G124, thereby preventing the cooling liquid L from flowing between the fourth minor optoelectronics transceiver optical cable gap G1424 and the fourth extending optical cable gap G124 via capillary action.

It should be noted that, in the embodiment shown in FIG. 12, when the minor optical cable connector 15 is removed from the cooling liquid L, the fourth minor optical cable connector sub-adhesive barrier layer 1534 is capable of preventing the cooling liquid L from flowing between the fourth minor optoelectronics transceiver optical cable gap G1424 and the fourth extending optical cable gap G124 via capillary action, and subsequently seeping out through the minor optical cable connector 15 to contaminate the environment.

It should be noted that the signal transmission cable of the present application may omit some components or structural steps and is not limited to the above content.

For example, the signal transmission cable of the present application may comprise: a major optoelectronics transceiver, an extending optical cable, and a major optical cable connector. The major optoelectronics transceiver comprises a major optoelectronics conversion module and a major optoelectronics transceiver optical cable. The major optoelectronics conversion module can convert a major electrical signal into a major optical signal or convert the major optical signal into the major electrical signal. The major optoelectronics transceiver optical cable is used to transmit the major optical signal and comprises a major optoelectronics transceiver optical cable joining end. One side of the extending optical cable comprises a major extending optical cable joining end. The major optical cable connector comprises a major optical cable connector carrier, a major optical cable connector cover, and a major optical cable connector adhesive. The major optical cable connector carrier comprises a major carrier joining space. The major extending optical cable joining end can join with the major optoelectronics transceiver optical cable joining end within the major carrier joining space, allowing the major optoelectronics transceiver optical cable to transmit the major optical signal to the extending optical cable. The extending optical cable can thus extend and increase the transmission distance of the major optical signal. Additionally, the major optical cable connector adhesive can bond the major extending optical cable joining end and the major optoelectronics transceiver optical cable joining end within the major carrier joining space, maintaining joining state of the major extending optical cable joining end and the major optoelectronics transceiver optical cable joining end and providing a sealed environment to prevent liquid infiltration. The major optical cable connector cover covers the major optical cable connector carrier to ensure that the major optical cable connector adhesive remains within the major carrier joining space.

In summary, the present application provides a signal transmission cable comprising an optoelectronics transceiver, an extending optical cable, and an optical cable connector. The optoelectronics transceiver comprises an optoelectronics transceiver optical cable capable of transmitting an optical signal. The extending optical cable can join with the optoelectronics transceiver optical cable to extend the transmission distance of the optical signal. As a result, the length of the optoelectronics transceiver optical cable does not need to vary based on different usage fields or methods, thereby enabling mass production of the optoelectronics transceiver and reducing manufacturing costs.

Additionally, the optical cable connector comprises an optical cable connector adhesive, which can bond the joint between the extending optical cable and the optoelectronics transceiver optical cable. When the signal transmission cable is immersed in cooling liquid, the optical cable connector adhesive can prevent the cooling liquid from infiltrating the signal transmission cable through the joint between the extending optical cable and the optoelectronics transceiver optical cable, thereby significantly enhancing the waterproof performance of the signal transmission cable.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A signal transmission cable, comprising:
a major optoelectronics transceiver, the major optoelectronics transceiver comprising a major optoelectronics conversion module and a major optoelectronics transceiver optical cable, the major optoelectronics conversion module converting a major electrical signal into a major optical signal, or the major optoelectronics conversion module converting the major optical signal into the major electrical signal, the major optoelectronics transceiver optical cable providing transmission of the major optical signal, the major optoelectronics transceiver optical cable comprising a major optoelectronics transceiver optical cable joining end;
an extending optical cable, one side of the extending optical cable comprising a major extending optical cable joining end; and
a major optical cable connector, the major optical cable connector comprising a major optical cable connector carrier, a major optical cable connector cover, and a major optical cable connector adhesive, the major optical cable connector carrier comprising a major carrier joining space, wherein,
the major extending optical cable joining end is joined with the major optoelectronics transceiver optical cable joining end within the major carrier joining space, such that the major optoelectronics transceiver optical cable transmits the major optical signal to the extending optical cable, and the extending optical cable extending to increase the transmission distance of the major optical signal; and
the major optical cable connector adhesive bonding the major extending optical cable joining end and the major optoelectronics transceiver optical cable joining end within the major carrier joining space, thereby maintaining the joined state of the major extending optical cable joining end and the major optoelectronics transceiver optical cable joining end, and providing a sealed environment for the major extending optical cable joining end and the major optoelectronics transceiver optical cable joining end, with the major optical cable connector cover enclosing the major optical cable connector carrier to retain the major optical cable connector adhesive within the major carrier joining space.

2. The signal transmission cable of claim 1, wherein the major optoelectronics transceiver optical cable further comprises a major optoelectronics transceiver optical cable coupling component, and the extending optical cable further comprises a major extending optical cable coupling component; wherein the major optoelectronics transceiver optical cable coupling component and the major extending optical cable coupling component are provided to join and transmit the major optical signal, and the major optical cable connector adhesive comprises adhesive that bonds the major optoelectronics transceiver optical cable coupling component and the major extending optical cable coupling component, so as to maintain the joining relationship between the major optoelectronics transceiver optical cable coupling component and the major extending optical cable coupling component.

3. The signal transmission cable of claim 1, wherein the major optoelectronics transceiver optical cable further comprises a major optoelectronics transceiver optical cable fiber, and the extending optical cable further comprises an extending optical cable fiber, the major optoelectronics transceiver optical cable fiber and the extending optical cable fiber providing transmission of the major optical signal, and the major optical cable connector adhesive bonding the major optoelectronics transceiver optical cable fiber and the extending optical cable fiber to maintain the relative positional relationship of the major optoelectronics transceiver optical cable fiber and the extending optical cable fiber.

4. The signal transmission cable of claim 3, wherein the major optoelectronics transceiver optical cable further comprises a major optoelectronics transceiver optical cable cladding, and the extending optical cable further comprises an extending optical cable cladding, wherein the major optoelectronics transceiver optical cable cladding surrounds the major optoelectronics transceiver optical cable fiber, and the refractive index of the major optoelectronics transceiver optical cable cladding is lower than that of the major optoelectronics transceiver optical cable fiber, to provide total internal reflection ensuring the transmission of the major optical signal within the major optoelectronics transceiver extending optical cable fiber, and the refractive index of the extending optical cable cladding is lower than that of the extending optical cable fiber, to provide total internal reflection ensuring the transmission of the major optical signal within the extending optical cable fiber; a first major optoelectronics transceiver optical cable gap is formed between the major optoelectronics transceiver optical cable cladding and the major optoelectronics transceiver optical cable fiber; a first extending optical cable gap is formed between the extending optical cable cladding and the extending optical cable fiber; and the major optical cable connector adhesive comprises a first major optical cable connector sub-adhesive barrier layer, the first major optical cable connector sub-adhesive barrier layer is configured to respectively bond the major optoelectronics transceiver optical cable fiber, the major optoelectronics transceiver optical cable cladding, the extending optical cable fiber, and the extending optical cable cladding, so as to block continuity between the first major optoelectronics transceiver optical cable gap and the first extending optical cable gap.

5. The signal transmission cable of 4, wherein the major optoelectronics transceiver optical cable further comprises a major optoelectronics transceiver optical cable cushioning layer, and the extending optical cable further comprises an extending optical cable cushioning layer; the major optoelectronics transceiver optical cable cushioning layer is coated around the major optoelectronics transceiver optical cable cladding so as to protect the major optoelectronics transceiver optical cable fiber; the extending optical cable cushioning layer is coated around the extending optical cable cladding so as to protect the extending optical cable fiber; a second major optoelectronics transceiver optical cable gap is formed between the major optoelectronics transceiver optical cable cushioning layer and the major optoelectronics transceiver optical cable cladding, and a second extending optical cable gap is formed between the extending optical cable cushioning layer and the extending optical cable cladding; and the major optical cable connector adhesive comprises a second major optical cable connector sub-adhesive blocking layer, which is bonded respectively to the major optoelectronics transceiver optical cable cladding, the major optoelectronics transceiver optical cable cushioning layer, the extending optical cable cladding, and the extending optical cable cushioning layer, so as to block continuity between the second major optoelectronics transceiver optical cable gap and the second extending optical cable gap.

6. The signal transmission cable of claim 5, wherein the major optoelectronics transceiver optical cable further comprises a major optoelectronics transceiver optical cable reinforcement layer, and the extending optical cable further comprises an extending optical cable reinforcement layer, wherein the major optoelectronics transceiver optical cable reinforcement layer surrounds the major optoelectronics transceiver optoelectronics transceiver optical cable gap is formed between the major optoelectronics transceiver optical cable strengthening layer and the major optoelectronics transceiver optical cable cushioning layer, and a third extending optical cable gap is formed between the extending optical cable strengthening layer and the extending optical cable cushioning layer; and the major optical cable connector adhesive comprises a third major optical cable connector sub-adhesive blocking layer, which is bonded respectively to the major optoelectronics transceiver optical cable cushioning layer, the major optoelectronics transceiver optical cable strengthening layer, the extending optical cable cushioning layer, and the extending optical cable strengthening layer, so as to block continuity between the third major optoelectronics transceiver optical cable gap and the third extending optical cable gap.

7. The signal transmission cable of claim 6, wherein the major optoelectronics transceiver optical cable further comprises a major optoelectronics transceiver optical cable outer sheath layer, and the extending optical cable further comprises an extending optical cable outer sheath layer, wherein the major optoelectronics transceiver optical cable outer sheath layer surrounds the major optoelectronics transceiver optical cable reinforcement layer to provide outer protection; a fourth major optoelectronics transceiver optical cable gap is formed between the major optoelectronics transceiver optical cable outer sheath layer and the major optoelectronics transceiver optical cable strengthening layer, and a fourth extending optical cable gap is formed between the extending optical cable outer sheath layer and the extending optical cable strengthening layer; and the major optical cable connector adhesive comprises a fourth major optical cable connector sub-adhesive blocking layer, which is bonded respectively to the major optoelectronics transceiver optical cable strengthening layer, the major optoelectronics transceiver optical cable outer sheath layer, the extending optical cable strengthening layer, and the extending optical cable outer sheath layer, so as to block continuity between the fourth major optoelectronics transceiver optical cable gap and the fourth extending optical cable gap.

8. The signal transmission cable of claim 1, further comprising:
a minor optoelectronics transceiver, the minor optoelectronics transceiver comprising a minor optoelectronics conversion module and a minor optoelectronics transceiver optical cable, the minor optoelectronics conversion module converting a minor electrical signal into a minor optical signal, or the minor optoelectronics conversion module converting the minor optical signal into the minor electrical signal, the minor optoelectronics transceiver optical cable providing transmission of the minor optical signal, the minor optoelectronics transceiver optical cable comprising a minor optoelectronics transceiver optical cable joining end;
the other side of the extending optical cable comprising a minor extending optical cable joining end; and
a minor optical cable connector, the minor optical cable connector comprising a minor optical cable connector carrier, a minor optical cable connector cover, and a minor optical cable connector adhesive, the minor optical cable connector carrier comprising a minor carrier joining space, wherein,
the minor extending optical cable joining end is joined with the minor optoelectronics transceiver optical cable joining end within the minor carrier joining space, such that the minor optoelectronics transceiver optical cable transmits the minor optical signal to the extending optical cable, and the extending optical cable is capable of extending to increase the transmission distance of the minor optical signal; and
the minor optical cable connector adhesive bonding the minor extending optical cable joining end and the minor optoelectronics transceiver optical cable joining end within the minor carrier joining space, thereby maintaining the joined state of the minor extending optical cable joining end and the minor optoelectronics transceiver optical cable joining end, and providing a sealed environment for the minor extending optical cable joining end and the minor optoelectronics transceiver optical cable joining end, with the minor optical cable connector cover enclosing the minor optical cable connector carrier to retain the minor optical cable connector adhesive within the minor carrier joining space.

9. The signal transmission cable of claim 8, wherein the minor optoelectronics transceiver optical cable further comprises a minor optoelectronics transceiver optical cable coupling component, and the extending optical cable further comprises a minor extending optical cable coupling component, the minor optoelectronics transceiver optical cable coupling component is joined with the minor extending optical cable coupling component to transmit the minor optical signal, and the minor optical cable connector adhesive is bonded to the minor optoelectronics transceiver optical cable coupling component and the minor extending optical cable coupling component so as to maintain the joining relationship between the minor optoelectronics transceiver optical cable coupling component and the minor extending optical cable coupling component.

10. The signal transmission cable of claim 8, wherein the minor optoelectronics transceiver optical cable further comprises a minor optoelectronics transceiver optical cable fiber, and the extending optical cable further comprises an extending optical cable fiber, the minor optoelectronics transceiver optical cable fiber and the extending optical cable fiber providing transmission of the minor optical signal, and the minor optical cable connector adhesive bonding the minor optoelectronics transceiver optical cable fiber and the extending optical cable fiber to maintain the relative positional relationship of the minor optoelectronics transceiver optical cable fiber and the extending optical cable fiber.

11. The signal transmission cable of claim 10, wherein the minor optoelectronics transceiver optical cable further comprises a minor optoelectronics transceiver optical cable cladding, and the extending optical cable further comprises an extending optical cable cladding, wherein the minor optoelectronics transceiver optical cable cladding surrounds the minor optoelectronics transceiver optical cable fiber, and the refractive index of the minor optoelectronics transceiver optical cable cladding is lower than that of the minor optoelectronics transceiver optical cable fiber, to provide total internal reflection ensuring the transmission of the minor optical signal within the minor optoelectronics transceiver optical cable fiber; the extending optical cable cladding surrounds the extending optical cable fiber, and the refractive index of the extending optical cable cladding is lower than that of the extending optical cable fiber, to provide total internal reflection ensuring the transmission of the minor optical signal within the extending optical cable fiber; and a first minor optoelectronics transceiver optical cable gap is formed between the minor optoelectronics transceiver optical cable cladding and the minor optoelectronics transceiver optical cable fiber; a first extending optical cable gap is formed between the extending optical cable cladding and the extending optical cable fiber; and the minor optical cable connector adhesive comprises a first minor optical cable connector sub-adhesive barrier layer, the first minor optical cable connector sub-adhesive barrier layer is configured to respectively bond the minor optoelectronics transceiver optical cable fiber, the minor optoelectronics transceiver optical cable cladding, the extending optical cable fiber, and the extending optical cable cladding, so as to block continuity between the first minor optoelectronics transceiver optical cable gap and the first extending optical cable gap.

12. The signal transmission cable of claim 11, wherein the minor optoelectronics transceiver optical cable further comprises a minor optoelectronics transceiver optical cable cushioning layer, and the extending optical cable further comprises an extending optical cable cushioning layer, wherein the minor optoelectronics transceiver optical cable cushioning layer surrounds the minor optoelectronics transceiver optical cable cladding to provide protection for the minor optoelectronics transceiver optical cable fiber; the extending optical cable cushioning layer surrounds the extending optical cable cladding to provide protection for the extending optical cable fiber; a second minor optoelectronics transceiver optical cable gap is formed between the minor optoelectronics transceiver optical cable cushioning layer and the minor optoelectronics transceiver optical cable cladding; a second extending optical cable gap is formed between the extending optical cable cushioning layer and the extending optical cable cladding; and the minor optical cable connector adhesive comprises a second minor optical cable connector sub-adhesive barrier layer, the second minor optical cable connector sub-adhesive barrier layer is configured to respectively bond the minor optoelectronics transceiver optical cable cladding, the minor optoelectronics transceiver optical cable cushioning layer, the extending optical cable cladding, and the extending optical cable cushioning layer, so as to block continuity between the second minor optoelectronics transceiver optical cable gap and the second extending optical cable gap.

13. The signal transmission cable of claim 12, wherein the minor optoelectronics transceiver optical cable further comprises a minor optoelectronics transceiver optical cable reinforcement layer, and the extending optical cable further comprises an extending optical cable reinforcement layer, wherein the minor optoelectronics transceiver optical cable reinforcement layer surrounds the minor optoelectronics transceiver optical cable cushioning layer to resist tensile force; the extending optical cable reinforcement layer surrounds the extending optical cable cushioning layer to resist tensile force; a third minor optoelectronics transceiver optical cable gap is formed between the minor optoelectronics transceiver optical cable reinforcement layer and the minor optoelectronics transceiver optical cable cushioning layer; a third extending optical cable gap is formed between the extending optical cable reinforcement layer and the extending optical cable cushioning layer; and the minor optical cable connector adhesive comprises a third minor optical cable connector sub-adhesive barrier layer, the third minor optical cable connector sub-adhesive barrier layer is configured to respectively bond the minor optoelectronics transceiver optical cable cushioning layer, the minor optoelectronics transceiver optical cable reinforcement layer, the extending optical cable cushioning layer, and the extending optical cable reinforcement layer, so as to block continuity between the third minor optoelectronics transceiver optical cable gap and the third extending optical cable gap.

14. The signal transmission cable of claim 13, wherein the minor optoelectronics transceiver optical cable further comprises a minor optoelectronics transceiver optical cable outer sheath layer, and the extending optical cable further comprises an extending optical cable outer sheath layer, wherein the minor optoelectronics transceiver optical cable outer sheath layer surrounds the minor optoelectronics transceiver optical cable reinforcement layer to provide outer protection; the extending optical cable outer sheath layer surrounds the extending optical cable reinforcement layer to provide outer protection; a fourth minor optoelectronics transceiver optical cable gap is formed between the minor optoelectronics transceiver optical cable outer sheath layer and the minor optoelectronics transceiver optical cable reinforcement layer; a fourth extending optical cable gap is formed between the extending optical cable outer sheath layer and the extending optical cable reinforcement layer; and the minor optical cable connector adhesive comprises a fourth minor optical cable connector sub-adhesive barrier layer, the fourth minor optical cable connector sub-adhesive barrier layer is configured to respectively bond the minor optoelectronics transceiver optical cable reinforcement layer, the minor optoelectronics transceiver optical cable outer sheath layer, the extending optical cable reinforcement layer, and the extending optical cable outer sheath layer, so as to block continuity between the fourth minor optoelectronics transceiver optical cable gap and the fourth extending optical cable gap.
